(19) United States
(12) Patent Application Publication
(10) Pub. No.: US 2009/0173919 A1
(43) Pub. Date: Jul. 9, 2009

(54) Conductive Ink Compositions

(75) Inventors: Dean C. Webster, Fargo, ND (US); Samali Datta, Fargo, ND (US); Douglas L. Schulz, Moorhead, MN (US)

Correspondence Address: Peter Rogalskyj;The Law Office of Peter Rogalskyj, P.O.Box 44, Livonia, NY, 14487-0044, US

(73) Assignee: NDSU RESEARCVH FOUNDATION, Fargo, ND (US)

(21) Appl. No.: 12/085,335

(22) PCT Filed: Nov. 22, 2006
(86) PCT No.: PCT/US2006/045220

§ 371 Date: May 21, 2008

Related U.S. Application Data
(60) Provisional application No. 60/738,743, filed on Nov. 22, 2005.
(60) Provisional application No. 60/740,220, filed on Nov. 28, 2005.
(60) Provisional application No. 60/793,982, filed on Apr. 21, 2006.

(51) Int. Cl. H01B 1/22; H01B 1/20

(52) U.S. Cl. 252/514; 252/500; 252/512

(57) ABSTRACT

Disclosed are conductive ink compositions that include at least one monomer containing exactly one ethylenically unsaturated group, one or more thermoplastic polymers, one or more free radical initiators, and conductive particles. Also disclosed are conductive thermoplastic materials which include at least one thermoplastic polymer produced by polymerization of one or more monomers containing exactly one ethylenically unsaturated group; and conductive particles dispersed in said thermoplastic polymer. The conductive ink compositions and thermoplastic materials can be used in the manufacture of electronic devices, such as radiofrequency identification (“RFID”) devices.

The present application claims the benefit of U.S. Provisional Patent Application Ser. No. 60/738,743, filed Nov. 22, 2005; U.S. Provisional Patent Application Ser. No. 60/740,220, filed Nov. 28, 2005; and U.S. Provisional Patent Application Ser. No. 60/793,982, filed Apr. 21, 2006, each of which provisional patent applications is hereby incorporated by reference.

The present invention was made with the support of the Department of Defense's Defense Microelectronics Activity Grant No. DMEA H94003-04-2-0406. The Federal Government may have certain rights in this invention.

### FIELD OF THE INVENTION

The present invention relates, generally, to conductive ink compositions and, more particularly, to conductive ink compositions that harden to conductive, tack-free, thermoplastic materials upon polymerization by radiation and/or heat.

### BACKGROUND OF THE INVENTION

Screen printing and ink-jet printing are straightforward, rapid, and simple methods for applying conductive wiring to printed circuit boards and other microelectronic devices for formation of interconnects. Conductive inks are typically formulated with a polymer binder system, solvent, and contain micro-sized metal particles, such as silver or copper, to provide conductivity. After application via screen printing or via ink-jet printing, the ink cures or hardens either through solvent evaporation or curing at elevated temperature to form a tack-free conductive trace. While the conductivity of the deposited metal-containing ink is much less than that of the metallic material, it is generally sufficient for many applications (Franey et al., “The Morphology and Corrosion Resistance of a Conductive Silver-Epoxy Paste,” J. Mater. Sci., 16(9):2360-2368 (1981) and Sanjoi et al., “Printing Radio Frequency Identification (RFID) Tag Antennas Using Inks Containing Silver Dispersions,” J. Disp. Sci. Tech., 25(4):513-521 (2004)).

Environmental regulations are putting pressure on the use of solvent borne inks and, thus, alternatives that do not emit hazardous air pollutants (e.g., organic solvents) are sought. UV curable polymer technology is a viable alternative, since these inks are liquid at application conditions, generally contain no organic solvent, and are converted into a hard, tack-free ink quickly using UV light. The binder system is typically comprised of low viscosity, multifunctional acrylates and a photoinitiator. Under the influence of the UV light, the photoinitiator decomposes to yield free radicals which then initiate the polymerization of the acrylate groups (Koleske, “Radiation Curing of Coatings,” West Conshohocken, Pa.: ASTM International (2002)). The multifunctional acrylates polymerize to a highly crosslinked, hard network.

In addition to forming simple interconnects, in many applications, screen-printed or ink-jet-printed conductive inks may also be used as a substrate for attachment of another conductive device. For example, a “bond pad” can be printed using the conductive ink and then using heat and pressure this bond pad can be attached to another similar bond pad or metallic conductor. In order for good electrical contact to be formed during this bonding process, the polymer binder system should be able to flow under the influence of heat and pressure. In the case of conventional solvent-borne inks having thermoplastic polymer binders, this is not a problem. However, for UV inks, the binder cannot flow since it is highly crosslinked.

In view of the above, a need exists for new conductive ink compositions, and the present invention is directed, in part, to meeting this need.

### SUMMARY OF THE INVENTION

The present invention relates to a conductive ink composition that includes at least one monomer containing exactly one ethylenically unsaturated group, one or more thermoplastic polymers, one or more initiators, and conductive particles.

The present invention also relates to a conductive thermoplastic material. The conductive thermoplastic material includes at least one thermoplastic polymer produced by polymerization of one or more monomers containing exactly one ethylenically unsaturated group; and conductive particles dispersed in the thermoplastic polymer.

### BRIEF DESCRIPTION OF THE DRAWINGS

FIGS. 1A-1C are schematic drawings of a method of using a conductive ink composition of the present invention for the manufacture of a radiofrequency identification electronic device.

FIG. 2 is a graph showing the thermogravimetric analysis curves in N₂ of different films formed from organic binders that are useful in the conductive ink compositions and thermoplastic materials of the present invention.

FIGS. 3A and 3B are graphs showing the dynamic mechanical analysis curves of two films formed from organic binders that are useful in the conductive ink compositions and thermoplastic materials of the present invention.

FIGS. 4A-4D are scanning electron microscopy (“SEM”) images of conductive fillers that are useful in the conductive ink compositions and thermoplastic materials of the present invention. FIG. 4A is an SEM image of glass micro-spheres coated with silver; FIG. 4B is an SEM image of silver flakes; FIG. 4C is an SEM image of silver acorns; and FIG. 4D is an SEM image of silver nanopowder.

### DETAILED DESCRIPTION OF THE INVENTION

One aspect of the present invention relates to a conductive ink composition that includes at least one monomer containing exactly one ethylenically unsaturated group, one or more thermoplastic polymers, one or more initiators, and conductive particles.

Any monomer containing exactly one double bond can be used in this invention. Examples of such monomers are those that contain exactly one double bond and that have low vapor pressure at ambient temperatures. Suitable monomers containing exactly one double bond include, for example, tetrahydrofurfuryl acrylate, methacrylic acid, isobornyl acrylate, alkoylated tetrahydrofurfuryl acrylate, acrylate ester glycol, cyclic trimethylol propane formal acrylate, N-vinyl pyrrolidone, acrylic acid, 2-(ethoxy ethoxy) ethyl acrylate, ethoylated phenol acrylate, and the like. Combinations of these and other monomers containing exactly one double bond can also be employed. For example, the conductive ink composition can include exactly one monomer containing exactly one ethylenically unsaturated group, exactly two monomers containing exactly one ethylenically unsaturated group, exactly three monomers containing exactly one ethylenically unsaturated group, exactly four monomers containing exactly one ethylenically unsaturated group, etc.

In addition to containing at least one monomer containing exactly one ethylenically unsaturated group, the conductive ink composition of the present invention also includes one or more thermoplastic polymers. Suitable thermoplastic polymers include those having a molecular weight of from about 1000 to about 1,000,000 g/mole, such as from about 2000 to about 500,000 g/mole, from about 5000 to about 300,000 g/mole, from about 10,000 to about 200,000 g/mole, etc.; those having a glass transition temperature in the range of −75° C. to 120° C., such as from about −75° C. to about 120° C., from −75° C. to 120° C., from about −50° C. to about 100° C., from −50° C. to 100° C., from about −30° C. to about 80° C., from 30° C. to 80° C., from about −10° C. to about 60° C., from −10° C. to 60° C., etc.; and/or those having a molecular weight of from about 1000 to about 1,000,000 g/mole and having a glass transition temperature in the range of −75° C. to 120° C. The thermoplastic polymer should be chosen such that it is compatible with the monomer. Illustratively, suitable thermoplastic polymers include poly(methyl methacrylate), poly(styrene), poly(butyl methacrylate), poly(butyl acrylate), etc. Combinations of these and other thermoplastic polymers can also be employed. For example, the conductive ink composition can include exactly one thermoplastic polymer, exactly two thermoplastic polymers, exactly three thermoplastic polymers, exactly four thermoplastic polymers, etc.

As noted above, the conductive ink composition of the present invention also includes one or more initiators. The initiator can be any initiator used in free radical polymerizations.

In certain embodiments, at least one initiator is a photoinitiator. In other embodiments, at least one initiator is a photoinitiator, and the conductive ink composition is substantially free from thermal initiators. In still other embodiments, at least one initiator is a thermal initiator. In yet other embodiments, at least one initiator is a thermal initiator, and the conductive ink composition is substantially free from photoinitiators. In still other embodiments, the conductive ink composition includes at least one photoinitiator and at least one thermal initiator.

Suitable photoinitiators include those that are active with ultraviolet as well as those that are active with visible light. Examples of suitable photoinitiators that can be used in the conductive ink compositions of the present invention include Irgacure 369 (2-benzyl-2-(dimethylamino)-1-[4-(4-morphonyl)phenyl]); Sarcure SR1135 (2,4,6-trimethylbenzodiphenyl phosphine oxide; 2,4,6-trimethylbenzophenone; 4-methyl bezophenone; oligo(2-hydroxy-2-methyl-1-(4-(1-methylvinyl)phenyl)propanone)); Darocur 1173 (2-hydroxy-2-methyl-1-phenyl-1-propanone); benzophenone; Irgacure184 (1-hydroxycyclohexyl phenyl ketone); Irgacure819 (phosphine oxide, phenylbis(2,4,6-trimethyl benzoyl), and the like. Bimolecular photoinitiators, such as those composed of an initiator (e.g., benzophenone) and amine synergist (e.g., an amine acrylate) can also be employed. Combinations of these and other photoinitiators can also be employed. For example, the conductive ink composition can include exactly one photoinitiator, exactly two photoinitiators, exactly three photoinitiators, etc.

Suitable thermal initiators include benzoyl peroxide, di-t-butyl peroxide, t-butyl peroctoate, t-amyl-peroxy-2-ethyl hexanoate, hydrogen peroxide, potassium or ammonium peroxydisulfate, dibenzoyl peroxide, lauryl peroxide, 2,2′-azobisisobutyronitrile, 2,2′-azobisisovaleronitrile t-butylperoxide, t-butyl hydroperoxide, sodium formaldehyde sulfoxylate, cumenehydroperoxide, dicumylperoxide, and the like. Combinations of these and other thermal initiators can also be employed. For example, the conductive ink composition can include exactly one thermal initiator, exactly two thermal initiators, exactly three thermal initiators, etc.

The conductive ink composition of the present invention also includes conductive particles, such as conductive metal particles. Examples of suitable conductive metal particles include metal powders, metal flakes, metal-coated beads, and combinations thereof. The conductive metal particles can include any suitable metal, such as aluminum, silver, gold, copper, and mixtures, alloys, and other combinations thereof. The conductive particles can be non-metallic, for example, as in the case where the conductive particles are made from or otherwise contain conductive polymeric materials. Specific examples of suitable conductive particles include silver flake, silver nanopowder, silver acorn, and silver-coated beads, such as silver-coated glass beads.

The conductive ink composition of the present invention can, optionally, include other components. The other components can be chosen to optimize the rheological and other properties of the conductive ink composition. However, they should be selected such that they do not adversely affect the conductivity of the ink composition. Moreover, the other components should be selected such that the conductive ink composition, after polymerization, forms a thermoplastic polymer and/or a polymer that flows and/or deforms upon application of heat and/or pressure.

For example, the conductive ink composition of the present invention can also include one or more monomers containing more than one ethylenically unsaturated group. When employed, the amount of monomer(s) containing more than one ethylenically unsaturated group should be limited such that the conductive ink composition, after polymerization, is a thermoplastic and not a thermoset. Illustratively, the conductive ink composition of the present invention can further include one or more monomers containing more than one ethylenically unsaturated group, wherein the weight ratio of monomers containing more than one ethylenically unsaturated group to monomers containing exactly one ethylenically unsaturated group is less than 1:5, such as less than 1:10, less than 1:20, less than 1:30, less than 1:40, less than 1:50, less than 1:60, less than 1:70, less than 1:80, less than 1:90, and/or less than 1:100. Alternatively, the conductive ink composition can be substantially free of monomers containing more than one ethylenically unsaturated group.

As further illustration, the conductive ink compositions of the present invention can also include a volatile organic solvent, such as butyl acetate, or other solvent. Alternatively, the conductive ink compositions of the present invention can be substantially free of volatile organic solvent.

It is preferred that the conductive ink compositions be formulated such that the conductive ink composition hardens to a tack-free material upon polymerization.

In the case where the conductive ink compositions contain at least one photoinitiator, it is preferred that the conductive ink compositions be formulated such that the conductive ink composition hardens to a tack-free material upon exposure to radiation, for example, upon exposure to radiation for less than 1 hour at an intensity of less than 100 mW/cm². It is also preferred that the conductive ink compositions be formulated such that the conductive ink composition harden to a tack-free, thermoplastic material (e.g., a conductive, tack-free, thermoplastic material) upon exposure to radiation, for example, upon exposure to radiation for less than 1 hour at an intensity of less than 100 mW/cm². As one skilled in the art will appreciate, the type of radiation to which the conductive ink composition should be exposed to effect curing depends on the nature of the monomer(s) present in the formulation and the kind(s) of photoinitiators employed. For example, curing can be effected by exposure to electromagnetic radiation of a suitable wavelength or range of wavelengths, such as visible radiation or UV radiation.

In the case where the conductive ink compositions contain at least one thermal initiator, it is preferred that the conductive ink compositions be formulated such that the conductive ink composition hardens to a tack-free material upon exposure to heat, for example, upon exposure to temperatures of less than 160° C. for less than 1 hour. It is also preferred that the conductive ink compositions be formulated such that the conductive ink composition harden to a tack-free, thermoplastic material (e.g., a conductive, tack-free, thermoplastic material) upon exposure to heat, for example, upon exposure to temperatures of less than 160° C. for less than 1 hour. As one skilled in the art will appreciate, the temperatures and duration of heating to which the conductive ink composition should be exposed to effect curing depends on the nature of the monomer(s) present in the formulation and the kind(s) of thermal initiators employed.

As one skilled in the art will appreciate, the selection of specific monomers (monomer(s) containing exactly one ethylenically unsaturated group and optional monomer(s) containing more than one ethylenically unsaturated group), specific thermoplastic polymers(s), specific conductive particles, and specific volatile organic solvent (if employed) and the relative amounts of each of these components will depend on the intended use of the conductive ink composition and the manner in which it is to be delivered. For example, the conductive ink composition can be formulated for ink-jet printing, or it can be formulated for screen printing.

The conductive ink compositions of the present invention can be produced by any suitable method. For example, the monomers (monomer(s) containing exactly one ethylenically unsaturated group and optional monomer(s) containing more than one ethylenically unsaturated group) can be mixed together with the thermoplastic polymer(s), with optional gentle heating and/or stirring, until a solution (e.g., a clear solution) is achieved. The initiators (e.g., photoinitiator(s), thermal initiator(s), or combinations thereof) can then be added to produce an organic binder for the conductive ink. The desired amount of conductive particles can then be slowly added to and mixed (e.g., using a mortar and pestle) with the organic binder to form a paste, preferably, a homogeneous paste (e.g., a paste that appears uniform to the unaided eye). Again, depending on how the conductive ink composition is to be employed, viscosity can be adjusted, for example, by adding a suitable volatile organic solvent, such as butyl acetate.

Once the conductive ink composition is produced, for example, by using the method discussed above, it can be applied a substrate (e.g., by ink-jet printing, screen printing, etc.) or it can be cast into a desired shape or formed into a film, etc., and then cured or otherwise polymerized into a thermoplastic material, to which thermoplastic material the present invention also relates. As noted above, depending on the kinds of initiators employed, polymerization of the conductive ink composition can be effected by exposure to suitable radiation, such as visible radiation or UV radiation for a suitable period of time (e.g., for from 1 second to 1 hour, such as from about 5 seconds to about 30 minutes, from 5 seconds to 30 minutes, from about 10 seconds to about 20 minutes, from 10 seconds to 20 minutes, from about 30 seconds to about 10 minutes, from 30 seconds to 10 minutes, from about 40 seconds to about 10 minutes, from 40 seconds to 10 minutes, from about 1 minute to about 5 minutes, and/or from 1 minute to 5 minutes; for less than 5 minutes, such as less than about 3 minutes, less than 3 minutes, less than about 2 minutes, less than 2 minutes, less than about 1 minute, less than 1 minute, less than about 45 seconds, less than 45 seconds, less than about 30 seconds, less than 30 seconds, less than about 15 seconds, less than 15 seconds; etc.) at a suitable intensity (e.g., from about 5 mW/cm² to about 300 mW/cm², such as from 5 mW/cm² to 300 mW/cm², from about 10 mW/cm² to about 200 mW/cm², from 10 mW/cm² to 200 mW/cm², from about 20 mW/cm² to about 100 mW/cm², from 20 mW/cm² to 100 mW/cm², from about 30 mW/cm² to about 60 mW/cm², from 30 mW/cm² to 60 mW/cm², and/or at about 40 mW/cm²); by heating at a suitable temperature (e.g., at from about 40° C. to about 180° C., such as from 40° C. to 180° C., from about 50° C. to about 175° C., from 50° C. to 175° C., from about 60° C. to about 170° C., from 60° C. to 170° C., from about 70° C. to about 165° C., and/or from 70° C. to 165° C.; at from about 50° C. to about 70° C., from 50° C. to 70° C., from about 70° C. to about 80° C., from 70° C. to 80° C., from about 80° C. to about 90° C., from 80° C. to 90° C., from about 90° C. to about 100° C., from 90° C. to 100° C., from about 100° C. to about 110° C., from 100° C. to 110° C., from about 110° C. to about 120° C., from 110° C. to 120° C., from about 120° C. to about 130° C., from 120° C. to 130° C., from about 130° C. to about 140° C., from 130° C. to 140° C., from about 140° C. to about 150° C., from 140° C. to 150° C., from about 150° C. to about 160° C., from 150° C. to 160° C., from about 170° C. to about 170° C., from 160° C. to 170° C., from about 170° C. to about 180° C., from 170° C. to 180° C.; etc.) for a suitable period of time (e.g., for from 20 seconds to 3 hours, such as from about 30 seconds to about 2 hours, from 30 seconds to 2 hours, from about 1 minute to about 90 minutes, from 1 minute to 90 minutes, from about 1 minute to about 60 minutes, from 1 minute to 60 minutes, from about 2 minutes to about 60 minutes, from 2 minutes to 60 minutes, from about 5 minutes to about 45 minutes, from 5 minutes to 45 minutes, from about 5 minutes to about 30 minutes, and/or from 5 minutes to 30 minutes; for less than 3 hours, such as less than about 2 hours, less than 2 hours, less than about 1 hour, less than 1 hour, less than about 45 minutes, less than 45 minutes, less than about 30 minutes, and/or less than 30 minutes; etc.), such as by heating at about 160° C. for about 20 minutes; or by a combination of exposure to radiation and heating.

The present invention, in another aspect thereof, relates to a conductive thermoplastic material that includes at least one thermoplastic polymer produced by polymerization of one or more monomers containing exactly one ethylenically unsaturated group; and conductive particles dispersed in the thermoplastic polymer.

In some embodiments, the at least one thermoplastic polymer is one that is produced by photopolymerization of one or more monomers containing exactly one ethylenically unsaturated group. In some embodiments, the at least one thermoplastic polymer is one that is produced by photopolymerization of one or more monomers containing exactly one ethylenically unsaturated group, and the conductive thermoplastic material is substantially free of thermoplastic polymers produced by thermal polymerization of one or more monomers containing exactly one ethylenically unsaturated group. In some embodiments, the at least one thermoplastic polymer is one that is produced by thermal polymerization of one or more monomers containing exactly one ethylenically unsaturated group. In some embodiments, the at least one thermoplastic polymer is one that is produced by thermal polymerization of one or more monomers containing exactly one ethylenically unsaturated group, and the conductive thermoplastic material is substantially free of thermoplastic polymers produced by photopolymerization of one or more monomers containing exactly one ethylenically unsaturated group. In some embodiments, the conductive thermoplastic material includes at least one thermoplastic polymer produced by simultaneous thermal and photo polymerization of one or more monomers containing exactly one ethylenically unsaturated group. In some embodiments, the conductive thermoplastic material comprises at least one thermoplastic polymer produced by photopolymerization of one or more monomers containing exactly one ethylenically unsaturated group and at least one thermoplastic polymer produced by thermal polymerization of one or more monomers containing exactly one ethylenically unsaturated group.

Illustratively, the thermoplastic polymer an be produced by polymerization of one or more of the following monomers: tetrahydrofurfuryl acrylate, methacrylic acid, isobornyl acrylate, alkoylated tetrahydrofurfuryl acrylate, acrylate ester glycol, cyclic trimethylol propane formal acrylate, N-vinyl pyrrolidone, acrylic acid, 2-(ethoxy ethoxy) ethyl acrylate, ethoylated phenol acrylate, and the like. Thermoplastic polymers that are produced by polymerization of combinations of these and other monomers containing exactly one double bond can also be employed. For example, the thermoplastic polymer can be the polymerization product of exactly one monomer containing exactly one ethylenically unsaturated group, of exactly two monomers containing exactly one ethylenically unsaturated group, of exactly three monomers containing exactly one ethylenically unsaturated group, of exactly four monomers containing exactly one ethylenically unsaturated group, etc.

The thermoplastic materials of the present invention also include conductive particles (e.g., conductive metal particles) dispersed in the thermoplastic polymer. Examples of suitable conductive metal particles include metal powders, metal flakes, metal-coated beads, and combinations thereof. The conductive metal particles can include any suitable metal, such as aluminum, silver, gold, copper, and mixtures, alloys, and other combinations thereof. The conductive particles can be non-metallic, for example, as in the case where the conductive particles are made from or otherwise contain conductive polymeric materials. Specific examples of suitable conductive particles include silver flake, silver nanopowder, silver acorn, and silver-coated beads, such as silver-coated glass beads.

The thermoplastic materials of the present invention can, optionally, include other components. The other components can be chosen, for example, the stability of the thermoplastic material or its glass transition temperature. However, the other components should be selected such that they do not adversely affect the conductivity of the thermoplastic materials. Moreover, the other components should be selected such that the thermoplastic material retains its thermoplasticity (i.e., its ability to flow and/or deform upon application of heat and/or pressure).

For example, in addition to containing the aforementioned at least one thermoplastic polymer produced by polymerization of one or more monomers containing exactly one ethylenically unsaturated group, the thermoplastic material of the present invention can also includes one or more additional thermoplastic polymers. The additional thermoplastic polymer can be one that is produced by photopolymerization, or it can be one that is not produced by photopolymerization; the additional thermoplastic polymer can be one that is produced by thermal polymerization, or it can be one that is not produced by thermal polymerization; and/or the additional thermoplastic polymer can be one that is produced by a combination of photopolymerization and thermal polymerization. Illustratively, the thermoplastic material of the present invention can further include a second thermoplastic polymer having, for example, having a molecular weight of from about 1000 to about 1,000,000 g/mole, such as from about 2000 to about 500,000 g/mole, from about 5000 to about 300,000 g/mole, from about 10,000 to about 200,000 g/mole, etc.; having a glass transition temperature in the range of −75° C. to 120° C., such as from about −75° C. to about 120° C., from −75° C. to 120° C., from about −50° C. to about 100° C., from −50° C. to 100° C., from about −30° C. to about 80° C., from −30° C. to 80° C., from about −10° C. to about 60° C., from −10° C. to 60° C., etc.; and/or having a molecular weight of from about 1000 to about 1,000,000 g/mole and having a glass transition temperature in the range of −75° C. to 120° C. The second thermoplastic polymer should be chosen such that it is compatible with the first thermoplastic polymer (i.e., the thermoplastic polymer produced by polymerization of one or more monomers containing exactly one ethylenically unsaturated group). Illustratively, suitable additional thermoplastic polymers that can be incorporated into the thermoplastic material of the present invention include poly(methyl methacrylate), poly(styrene), poly(butyl methacrylate), poly(butyl acrylate), etc. Combinations of these and other thermoplastic polymers can also be employed. For example, the thermoplastic materials can include exactly one additional thermoplastic polymer, exactly two additional thermoplastic polymers, exactly three additional thermoplastic polymers, exactly four additional thermoplastic polymers, etc.

Additionally or alternatively, the conductive thermoplastic materials of the present invention can also include one or more thermoset polymers. When employed, the amount of thermoset polymers should be limited such that the thermoplastic material is a thermoplastic and not a thermoset. Illustratively, the conductive thermoplastic materials of the present invention can further include one or more thermoset polymers, wherein the weight ratio of thermoset polymers to thermoplastic polymers is less than 1:5, such as less than 1:10, less than 1:20, less than 1:30, less than 1:40, less than 1:50, less than 1:60, less than 1:70, less than 1:80, less than 1:90, and/or less than 1:100. Alternatively, the conductive thermoplastic materials can be substantially free of thermoset polymers.

The thermoplastic materials of the present invention and those produced in accordance with the above-described method (e.g., by polymerization of a conductive ink composition of the present invention) can be used in the production of electronic devices, and the present invention, in yet another aspect thereof, relates to such electronic devices.

More particularly, such electronic devices of the present invention include two or more electronic components in electrical communication with one another via one or more conductive traces and/or interconnects, where at least some of the conductive traces and/or interconnects include a thermoplastic material of the present invention or a thermoplastic material produced by polymerization of a conductive ink composition of the present invention. The electronic components that are in electrical communication with one another via the one or more conductive traces and/or interconnects can be the same or different, and they can be selected from resistors, capacitors, transistors, integrated circuits or other electronic chips, diodes, antennae, and grounds (e.g., grounding straps, grounding bars, etc).

As used herein, “electronic devices” are meant to include any device that includes electronic components. Illustratively, they are meant to include, circuit boards, computers, cell phones, PDAs, electronic games, data storage and retrieval devices, cameras, radio frequency identification (“RFID”) devices, and the like.

As is evident from the above discussion, the thermoplastic materials of the present invention and those produced in accordance with the above-described method (e.g., by polymerization of a conductive ink composition of the present invention) provide an electrical connection between at least two electronic components of the electronic device. The thermoplastic material can also provide a mechanical bond with at least one of the electronic components. This can be achieved, for example, by applying heat and/or pressure sufficient to cause the thermoplastic material to flow and/or deform to produce a mechanical bond with the electronic component.

It will be appreciated that electronic devices frequently include non-electronic components (e.g., insulating layers, encapsulation layers, plastic structural components, insulating housings etc.), and the above-described thermoplastic materials can also provide a mechanical bond with one or more such non-electronic components of the electronic device. This can be achieved, for example, by bringing the thermoplastic material into contact with the non-electronic component and applying heat and/or pressure sufficient to cause the thermoplastic material to deform and produce a mechanical bond with the non-electronic component.

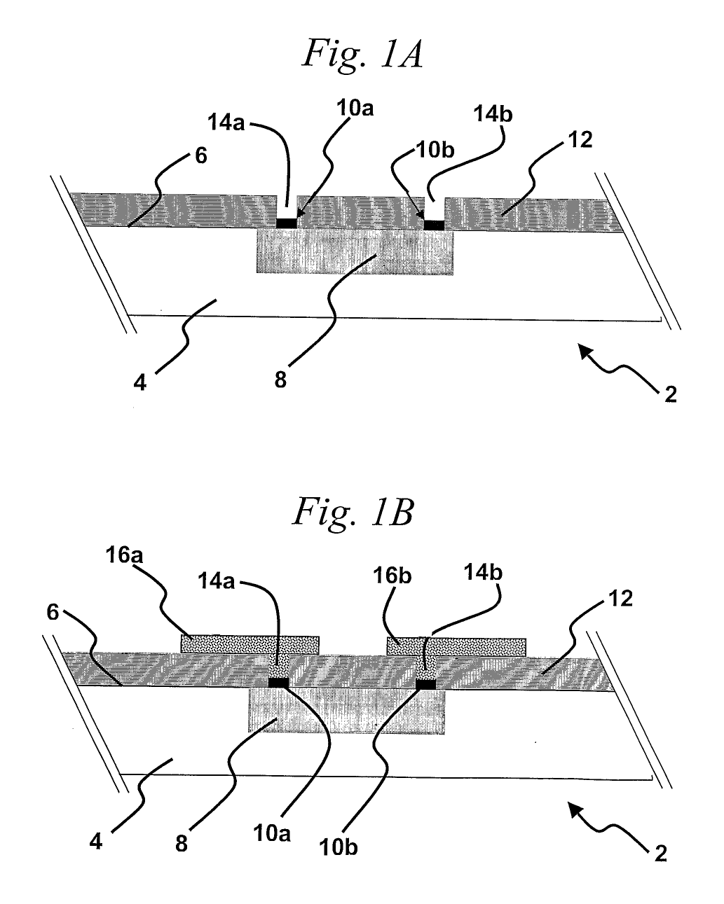

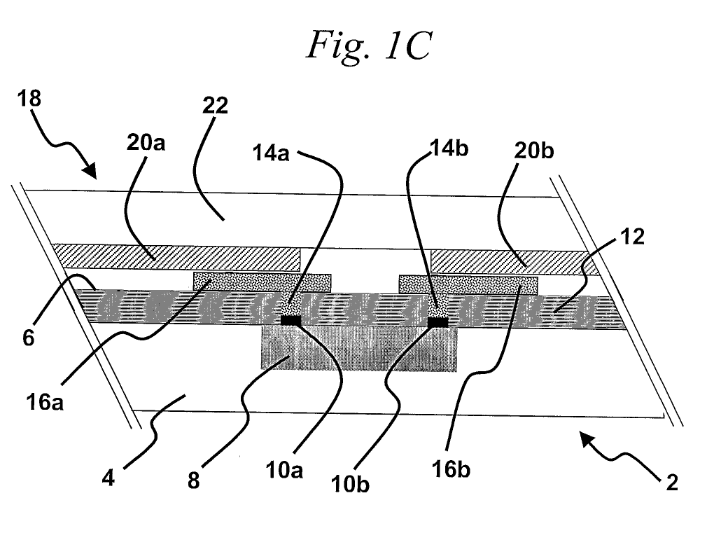

One method for using a conductive ink composition of the present invention to produce a thermoplastic material useful in the fabrication of electronic devices is schematically illustrated in FIGS. 1A-1C and is described below. While the method illustrated in FIGS. 1A-1C shows how remnant thermoplasticity in the cured conductive ink composition can be used to form electrical interconnects between electronic components that are disposed on two separate flexible webs, it will be appreciated that the method can be used to form electrical interconnects between electronic components disposed on other substrates (e.g., rigid circuit boards) or between electronic components that are not disposed on a substrate.

Referring to FIG. 1A, there is shown web 2 in an unrolled state. Web 2 includes flexible web-based substrate 4 having surface 6. Integrated circuit 8 includes bond pads 10a and 10b and is embedded in flexible web-based substrate 4. Web 2 further includes encapsulation layer 12 disposed on surface 6 of flexible web-based substrate 4. Encapsulation layer 12 includes vias 14a and 14b which are aligned with and provide access to integrated circuit 8's bond pads 10a and 10b. In RFID fabrication technology, this roll is commonly referred to as a “strap roll”

Conductive ink composition 16 is deposited (e.g., via high-speed screen printing) onto specific sites on web 2. More particularly, in the embodiment illustrated in FIG. 1B, conductive ink composition sites 16a and 16b are printed through vias 14a and 14b to make connection to integrated circuit 8's bond pads 10a and 10b. Curing of conductive ink composition sites 16a and 16b renders the surfaces of conductive ink composition sites 16a and 16b tack-free. After curing, web 2 can be used immediately in a second manufacturing step (described below), or it can be rolled for storage prior to being used in the second manufacturing step.

In a second manufacturing step, illustrated in FIG. 1C, web 2 is placed in contact with antenna web (web 18), which includes a radiofrequency dipole antenna (20a and 20b) attached to flexible substrate 22. More particularly, radiofrequency dipole antenna components 20a and 20b on antenna web 18 are aligned over are brought into contact with conductive ink composition sites 16a and 16b on web 2. Radiofrequency dipole antenna components 20a and 20b on antenna web 18 are then bonded both electrically and mechanically to conductive ink composition sites 16a and 16b on web 2, for example by a moderate thermal treatment (e.g., T<150° C.) in air with roller-pressure being applied between the two webs. Following the pressure/thermal treatment, the bonded strap/antenna can be taken up onto a single roll.

As illustrated in FIGS. 1A-1C, a first electronic component can be bonded or otherwise connected, both electrically and mechanically, to a second electronic component with a single application of the conductive ink composition of the present invention, for example, by application of heat and/or pressure to the solidified (tack-free) thermoplastic polymer produced by polymerization of the conductive ink composition, the mechanical bond to the first electronic component being formed prior to the conductive ink composition's being hardened to a tack-free state (e.g., by photopolymerization, thermal polymerization, etc,) and the mechanical bond to the second electronic component being formed after the conductive ink composition's being hardened to a tack-free state. In the context of RFID fabrication, for example, straps can thus be connected electrically and mechanically to antennae using a single deposition (or strike) of conductive ink.

The present invention is further illustrated by the following examples.

### EXAMPLES

### Example 1

### Preparation and Characterization of Solvent-Free UV-Curable Conductive Inks

This Example 1 and the following Examples 2-3 describe screen-printable conductive inks that are hardened using UV radiation. The binder system consists of low volatility monofunctional acrylate monomer, a thermoplastic polymer, and a photoinitiator. Conductivity is provided by silver particles. The polymerizable monomer functions as a reactive diluent for the thermoplastic polymer and, upon exposure to UV radiation, polymerizes to a linear polymer. Thus, the final ink remains thermoplastic and can be heat bonded to another conductive material.

The monomers, photoinitiators, their respective suppliers' names, and the abbreviations used in these Examples are shown in Table 1. Solid PMMA resin having a MW=120,000 was purchased from Aldrich. Silver flakes having dimensions less than 10 micron were purchased from Aldrich. Glass spheres coated with silver and having average diameter 14 micron were purchased from Potters Industries. Silver nano-powder having average diameter 150 nm, and raspberry shaped silver particles (silver acorns) were obtained from Inframat Advanced Materials. The average dimension of the latter was 0.7-1.5 μm. All of the materials were used as received. For comparison purposes, two different commercial conductive inks were selected, namely, Acheson Electrodag 479SS and Allied Chemical UVAG0010, designated as “Commercial Ink 1” and “Commercial Ink 2”, respectively.

TABLE 1

| Monomer/ | Commercial | Supplier's | Abbreviation |
|---|---|---|---|
| Photoinitiator | Name | Name | Used |
| Tetrahydrofurfuryl | SR 285 | Sartomer | THFA |
| acrylate | | | |
| Isobornyl acrylate | SR 506D | Sartomer | IBA |
| Alkoxylated tetrahydro- | CD 611 | Sartomer | ATHFA |
| furfuryl acrylate | | | |
| Acrylate ester | CD 277 | Sartomer | ACES |
| Cyclic trimethylol | SR 531 | Sartomer | CTMPFA |
| propane formal | | | |
| acrylate | | | |
| Oxyethylated phenol | Ebecryl | UCB | OEPA |
| acrylate | 110 | Chemicals | |
| 2-(2 ethoxyethoxy) | SR 256 | Sartomer | EOEOEA |
| ethyl acrylate | | | |
| Combination of | SR 1135 | Sartomer | PI 1 |
| phosphine oxide, | | | |
| trimethyl | | | |
| benzophenone, methyl | | | |
| benzophenone and other | | | |
| oligomeric ketone | | | |
| based compounds | | | |
| Combination of alpha- | Irgacure | Ciba | PI 2 |
| amino ketones and | 369 | | |
| blends | | | |
| 1-Hydroxycyclohexyl | Irgacure | Ciba | PI 3 |
| phenyl ketone | 184 | | |
| Benzophenone | Darocur BP | Ciba | Benzophenone |
| Reactive amine | CN 373 | Sartomer | AASYN |
| acrylate synergist | | | |

The binder formulation recipes containing monomer(s), photoinitiators and with or without polymer were prepared by mixing using a magnetic stirrer with occasional heating to accelerate the dissolution of the polymer. The silver-containing ink paste formulations were prepared by mixing the respective ingredients using a mortar and pestle until a visibly homogeneous mixture was obtained.

For the solidification/tack-free time study, the liquid binder mixture was cast onto glass panels with a doctor blade having a 4 mil (101.6 μm) gap. Curing was accomplished by Dymax EC-20 lamp at 365 nm, and 35 mW/cm². For studying the tack-free time of the ink pastes, films were cast on glass panels using a 2 mil (50.8 μm) gap doctor blade and curing was done as before. For the composition containing silver nano powder and silver flakes (formulation E4), the film was cured by 10 minutes UV curing followed by 10 minutes oven curing at 125° C.

Glass transition temperatures of the polymers were determined using differential scanning calorimetry (“DSC”). Tests were carried out by heating the samples at a rate of 10° C./minute in a TA Instruments Q-1000. Thermogravimetric analysis (“TGA”) was carried out under nitrogen, at a heating rate of 10° C./minute up to 300° C. in TA Instruments Q-500. Dynamic mechanical analysis was carried out using a TA Instruments Q-800 DMA. The samples were tested under tension from −70° C. to 110° C. at a heating rate of 3° C./minute.

For measuring surface resistivity (Ω/square), the following procedure was used. First, a rectangle was scribed using a razor blade on the cured ink film (glass panel), and its length and width were measured in mm. Approximate dimensions of the scribed area were 50 mm length by 1-2 mm in width. The length divided by the width gives the number of “squares”. Resistance of the rectangle was measured at its two ends using probes and a Wavetek meterman multimeter. Finally, surface resistivity was obtained by dividing the resistance value by the number of squares. Multiplication of the surface resistivity value by the thickness of the film (in mil) would give the volume resistivity (Ω/square/mil). All the volume resistivity values presented in this paper were measured on screen printed lines.

For scanning electron microscopy (“SEM”) experiments, samples were mounted on aluminum mounts and coated with gold using a Technics Hummer II sputter coater. Images were obtained using a JEOL JSM-6300 scanning electron microscope.

Screen printing was carried out using a Milara Semitouch Semiautomatic Screen Printer using the following parameters: squeegee speed of 1.5 to 3.0 in/sec; squeegee pressure of 15 to 25 lb/square inch; snap off of 0-10 mils; and squeegee hardness of 70-90 durometers. The substrate for screen printing was an FR4 board.

### Example 2

### Studies and Characterization of Binder Systems

A typical binder system for a UV curable coating or ink composition includes a multifunctional oligomer, multifunctional diluent(s), and a photoinitiator. Upon exposure to UV light, the photoinitiator initiates polymerization and, since the oligomers and diluents are typically multifunctional, a highly crosslinked film is produced. Due to the crosslinking, the ink film will not reflow on the application of heat; thus, in applications where it is desired to thermally bond the ink to another conductive material, a good bond cannot be formed. In view of this, a new type of binder system is needed that will initially be liquid for deposition using printing (e.g., screen printing, ink-jet printing, etc.), rapidly harden to a tack-free ink following exposure to UV radiation, but then maintain thermoplasticity so that it can be thermally attached to another conductive material.

While a number of binder system designs were considered, a system where the photopolymerization of a liquid monofunctional monomer to a linear polymer having a sufficient T_{g} to be tack free appeared to be a reasonable approach. A large number of potential monomers are available; however, commonly used monomers, such as butyl acrylate or methyl methacrylate, while having extremely low viscosity, are also highly volatile at ambient temperatures. Thus, these may not be ideal for this application. In addition, these monomers have noxious odor. Several monomers, however, were identified that have low volatility. These are illustrated below:

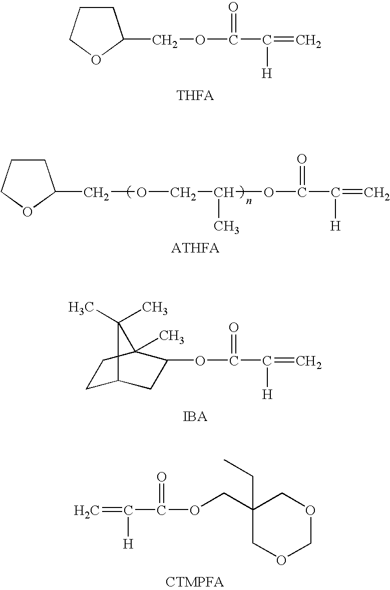

Since these monomers have relatively low viscosities, a material that can impart a higher viscosity to the ink is also desired as a component of the binder system. Thermoplastic acrylic copolymers are readily available commercially. Thus, the binder system consists of a blend of a thermoplastic polymer, PMMA in this case, along with the monomer(s) and the necessary free radical photoinitiator(s).

In the following discussion, the time taken by the liquid monomers to form solid film under the influence of UV radiation has been described as tack-free time or solidification time, rather than the commonly used phrase “cure time”. While the term curing generally indicates that a liquid coating or ink has been converted to a dry material, often the term indicates that a cross-linking reaction has occurred. In this case, however, the system undergoes photoinitiated linear free radical polymerization giving a thermoplastic polymer chain. Thus “tack-free time” indicates the time needed by the system when the monomers has reacted enough to give solid film.

Initial formulations were prepared to determine the effect of monomer and photoinitiator combinations on the solidification or tack-free time of the binder system. These formulations are summarized in Table 2.

TABLE 2

| | | | Polymer | | | |
|---|---|---|---|---|---|---|
| | Monomer | | (PMMA | Photoinitiator | | Solidifi- |
| | | Amount | resin) | | Amount | cation |
| No. | Type | (g) | (g) | Type | (%) | time (s) |
| 1 | THFA | 10 | 1.0 | PI 2 | 5.17 | 30 |
| 2 | THFA | 10 | 2.5 | Benzo- | 2.84 | |
| | | | | phenone | | |
| | | | | AASYN | 5.68 | 5 |
| | | | | PI 2 | 2.84 | |
| 3 | THFA | 10 | 2.5 | Benzo- | 2.84 | |
| | | | | phenone | | |
| | | | | AASYN | 5.68 | 25 |
| | | | | PI 3 | 2.84 | |
| 4 | THFA | 10 | 2.5 | PI 1 | 2.84 | |
| | | | | AASYN | 5.68 | 3 |
| | | | | PI 2 | 2.84 | |
| 5 | IBA | 5.0 | — | PI 1 | 5.0 | |
| | | | | AASYN | 8.33 | 10 |
| | | | | PI 2 | 3.33 | |
| 6 | ATHFA | 5.0 | — | PI 1 | 5.0 | |
| | | | | AASYN | 8.33 | 15 |
| | | | | PI 2 | 3.33 | |
| 7 | ACES | 5.0 | — | PI 1 | 5.0 | |
| | | | | AASYN | 8.33 | 10 |
| | | | | PI 2 | 3.33 | |
| 8 | CTMPFA | 5.0 | — | PI 1 | 5.0 | |
| | | | | AASYN | 8.33 | 6 |
| | | | | PI 2 | 3.33 | |
| 9 | THFA | 5.0 | — | PI 1 | 5.0 | |
| | | | | AASYN | 8.33 | 2 |
| | | | | PI 2 | 3.33 | |
| 10 | OEPA | 5.0 | — | PI 1 | 5.0 | |
| | | | | AASYN | 8.33 | 15 |
| | | | | PI 2 | 3.33 | |
| 11 | EOEOEA | 5.0 | — | PI 1 | 5.0 | |
| | | | | AASYN | 8.33 | 30 |
| | | | | PI 2 | 3.33 | |

It can be readily seen that the photoinitiator system consisting of PI 1, PI 2, and the amine acrylate synergist gave the shortest tack free time compared to the other combinations. It is also apparent that among different monomers THFA polymerizes faster than the other monomers under the test conditions. Also, IBA and CTMPFA showed reasonably fast tack free times. In the studies of the binder system alone, we wanted to achieve an extremely short tack free time since it was believed that the addition of the silver particles would serve to scatter the UV light and extend the time for curing.

Five different binder systems were developed based on the results of the screening experiments to be used with the silver particles. The binder system compositions are listed in Table 3.

TABLE 3

| | | | | Wt % of | | |
|---|---|---|---|---|---|---|
| | | | Wt % | photo- | Tack | |
| Formu- | | Wt. % | of | initiator | free | DSC |
| lation | | of | PMMA | combina- | time | T_{g} |
| ID | Monomer(s) | monomer | resin | tion^{a} | (s) | (° C.) |
| A | THFA | 76.27 | 8.47 | 15.26 | 6 | −24.42 |
| B | THFA | 31.75 | 7.94 | 12.69 | 5 | −23.52 |
| | CTMPFA | 31.75 | | | | |
| | ACES | 15.87 | | | | |
| C | THFA | 55.11 | 7.87 | 13.40 | 10 | −28.67 |
| | IBA | 11.81 | | | | |
| | ACES | 11.81 | | | | |
| D | THFA | 31.50 | 7.87 | 13.39 | 5 | −22.78 |
| | CTMPFA | 31.50 | | | | |
| | ATHFA | 15.74 | | | | |
| E | THFA | 28.22 | 6.45 | 12.91 | 10 | −2.77 |
| | CTMPFA | 32.26 | | | | |
| | IBA | 20.16 | | | | |

^{a}A mixture of PI 1, PI 2, and AASYN was used.

A range of tack free times and glass transition values of the binders was achieved depending on the composition of the binder. Comparatively higher T_{g}s were observed when the CTMPFA was present in the formulation. FIG. 2 shows the thermal stability of the hardened binder systems from the TGA experiments under nitrogen. Comparison of the monomer combinations in Table 3 and the TGA curves in FIG. 2 readily indicates that the binder film has less thermal stability when CTMPFA was present in the formulation. However, even the least thermally stable polymer also retained more than 95% of its original weight at temperature around 140° C., which is the proposed processing temperature of the hardened inks.

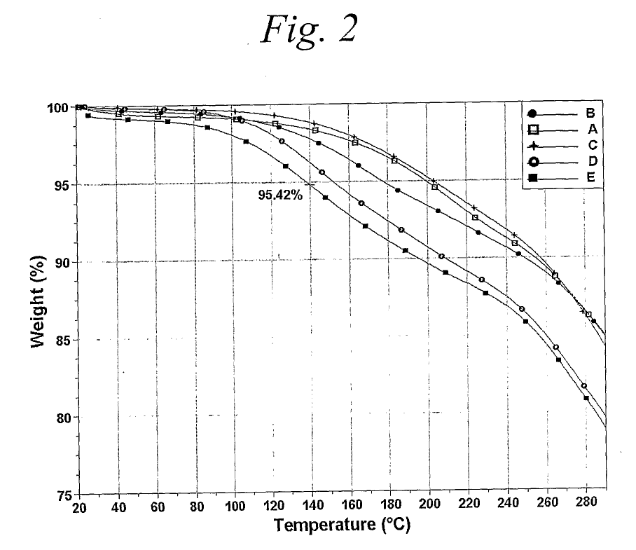

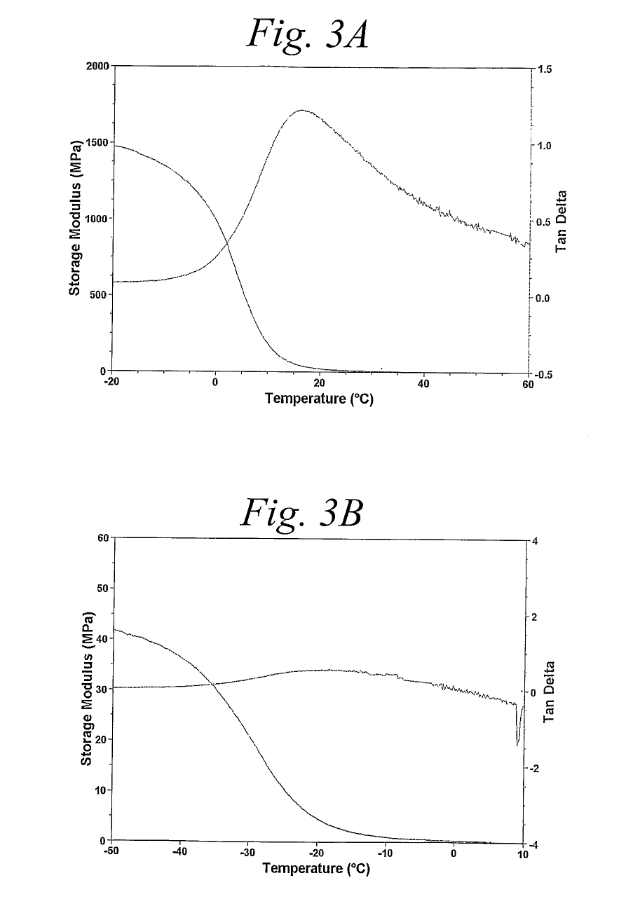

The thermo-mechanical properties of representative binder films C and E are illustrated in FIGS. 3A and 3B, respectively. Comparison of the two curves indicates that, for the lower T_{g} polymer, the modulus of the system at ambient temperature is also lower. Additionally, it can be seen for both the curves that above the T_{g}, the elastic modulus quickly dropped to zero indicating melt flow and verifying the inherent thermoplastic nature of the polymer binder system.

### Example 3

### Conductive Inks and Properties Thereof

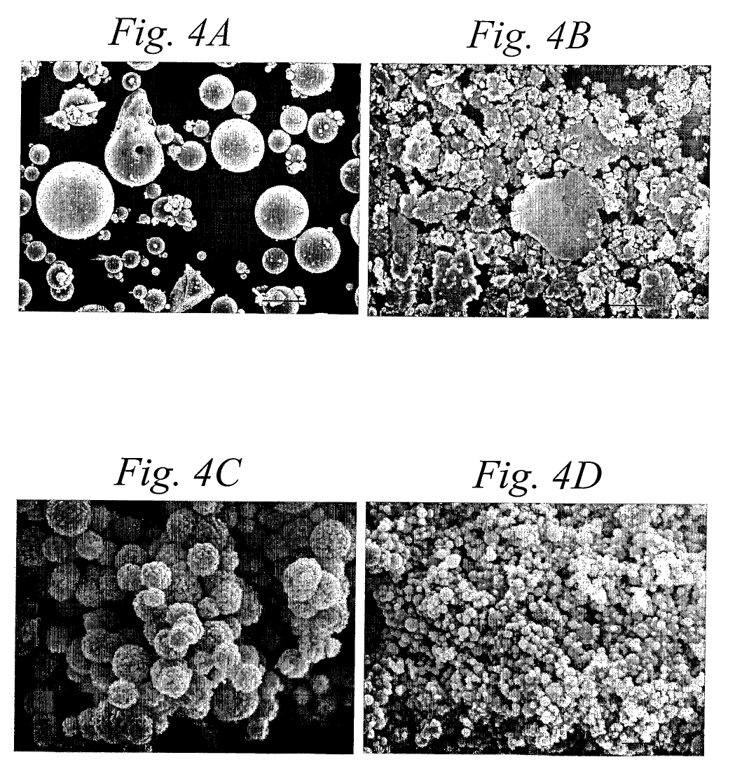

While making conductive ink with different binder formulations, the main objective was to obtain the highest possible conductivity, good screen printability at a minimum tack free time. Four types of conductive silver particles were evaluated and SEM micrographs are shown in FIGS. 4A-4D. The silver-coated glass microspheres (FIG. 4A) range from 8 to 20 μm in diameter, have a mean particle diameter of 14 μm and possess a density of 2.7 g/cm³ with an overall silver content of 12 weight percent. The silver flakes (FIG. 4B) are irregular in shape with diameters less than 10 μm and thickness estimated at 100 nm to give an aspect ratio of 100:1. The acorn-shaped silver nanopowders (FIG. 4C) appear to be sub 100 nm particles in micron-sized agglomerates. Finally, the silver nanopowder (FIG. 4D) has particles sizes ranging from 100 nm to 1 μm with some 2 μm agglomerates present.

Table 4 shows ink paste formulations where glass micro-spheres coated with silver and silver flakes were used as the major conductive fillers.

TABLE 4

| | Vol. % of | Vol. % of | Vol. % of | Vol. % of | Surface |
|---|---|---|---|---|---|
| Ink | organic | Ag-glass | silver | silver | resistivity |
| ID^{a} | phase | beads | flakes | acorn | (Ω/square) |
| A1 | 64.63 | 28.09 | 7.28 | — | 1.21 |
| B1 | 65.00 | 28.00 | 7.00 | — | 5.74 |
| B2 | 64.37 | 27.73 | 7.90 | — | 2.00 |
| C1 | 65.38 | 27.48 | 7.13 | — | 7.46 |
| C2 | 64.84 | 27.96 | 7.20 | — | 2.55 |
| C3 | 63.65 | 29.93 | 6.42 | — | 4.13 |
| E1 | 63.40 | 30.10 | 6.50 | — | 0.53 |
| E2 | 63.00 | 30.00 | 7.00 | — | 0.80 |
| E3 | 63.00 | 30.00 | 6.40 | 0.60 | 0.42 |

^{a}The letter in the ID refers to the binder system in Table 3.

The formulation E3 also contains silver acorn-shaped particles as an additional conductive filler. It can be said that the electrical properties of the final composite film depend both on the type and amount of individual filler and also on the binder composition. The tack free time for the compositions described in Table 4 varied between 15 seconds and 60 seconds. It has been reported that flake shaped fillers imparts unsatisfactory cure (U.S. Pat. No. 3,968,056 to Bolon et al., which is hereby incorporated by reference). Hence, in each case a combination different types, shapes, and sizes of fillers were evaluated. However, the main disadvantage of the conductive composites containing glass micro-spheres coated with silver as one of the conductive filler was that resistance value was always too high for the required application for all the formulations. None of the systems explored provided the level of conductivity desired for this application.

Since the silver coated glass spheres did not provide sufficient conductivity, a formulation was developed that eliminated these as the conductive material. Table 5 shows an ink composition containing silver nano powder and silver flakes as the conductive particles with the binder formulation E and the overall composition is designated as E4.

TABLE 5

| Composition | Wt. % | Vol % |
|---|---|---|
| Binder formulation E | 19.0 | 71.0 |
| Benzoyl peroxide | 0.5 | |
| Silver nanopowder | 37.9 | 14.5 |
| Silver flakes | 37.9 | 14.5 |
| Butyl acetate | 4.7 | |

Due to the very high viscosity of the system, a solvent needed to be included in the formulation to reduce the viscosity to a level where screen printing could be carried out. In addition to UV-radiation curing, oven heating was also used to evaporate the solvent as well as to get the residual monomers to polymerize, initiated by thermal initiator benzoyl peroxide.

This ink was printed on an FR4 board using screen printing along with formulation C3 and commercial solvent-borne and UV curable inks. Although here the tack free time was prolonged, the conductivity was greatly improved. Table 6 shows some of the key properties of the experimental formulations compared to few commercial formulations. The conductivity of the formulation containing the silver flakes and nanopowder is significantly better than that of the commercial UV cured ink and similar to the commercial solvent-borne ink.

TABLE 6

| | | | Ink | Ink |
|---|---|---|---|---|
| | Commercial | Commercial | Formulation | Formulation |
| Properties | Ink 1 | Ink 2 | C3 | E4 |
| Curing | Heat | UV curing | UV curing | UV + heat |
| method | | | | |
| Presence of | Yes | Solventless | Solventless | Low |
| solvent | | | | |
| Screen | Very good | — | Good | Needs |
| printability | | | | optimization |
| Resistivity | <0.02 | 0.285 | 0.856 | 0.074 |
| (Ω/sq./mil) | | | | |

### Example 4

### Preparation and Characterization of Solvent-Free Heat-Curable Conductive Inks

An illustrative binder system for heat-curable conductive inks is set forth in Table 7.

TABLE 7

| | | Wt. % | Wt % of | |
|---|---|---|---|---|
| Formulation | Monomer | of | PMMA | Wt % of thermal |
| ID | (s) | monomer | resin | initiator |
| 59 | THFA | 31.67 | 7.24 | 2.26 |
| | CTMPFA | 36.20 | | |
| | IBA | 22.34 | | |

The average molecular weight of the solid PMMA resin is 120,000 g/mol. Table 8 shows ink paste formulations for heat-curable conductive inks where silver nanopowder and silver flakes are used as the major conductive fillers.

TABLE 8

| | Wt. % of | Wt. % of | Wt. % of | |
|---|---|---|---|---|
| Ink | organic | silver | silver | t-butyl |
| ID^{a} | phase^{a} | flakes | nanopowder | acetate |
| 59a | 19.04 | 38.10 | 38.10 | 4.76 |
| 59b | 18.39 | 36.78 | 36.78 | 8.05 |

^{a}Binder formulation ID 59 from Table 8 is used as the organic phase.

The silver flakes are <10 micron (Aldrich), and the silver nanopowder is of 150 nm average diameter (Inframat Advanced Materials).

Although preferred embodiments have been depicted and described in detail herein, it will be apparent to those skilled in the relevant art that various modifications, additions, substitutions and the like can be made without departing from the spirit of the invention and these are therefore considered to be within the scope of the invention, as defined in the claims which follow.

What is claimed is:

1. A conductive ink composition comprising:
at least one monomer containing exactly one ethylenically unsaturated group;
one or more thermoplastic polymers;
one or more initiators; and
conductive particles.

2. A conductive ink composition according to claim 1 which, after polymerization, forms a thermoplastic polymer.

3. A conductive ink composition according to claim 1 which, after polymerization, forms a polymer that flows and/or deforms upon application of heat and/or pressure.

4. A conductive ink composition according to claim 1 which is substantially free of monomers containing more than one ethylenically unsaturated group.

5. A conductive ink composition according to claim 1 which further comprises one or more monomers containing more than one ethylenically unsaturated group, wherein the weight ratio of monomers containing more than one ethylenically unsaturated group to monomers containing exactly one ethylenically unsaturated group is less than 1:5.

6. A conductive ink composition according to claim 1 which further comprises one or more monomers containing more than one ethylenically unsaturated group, wherein the weight ratio of monomers containing more than one ethylenically unsaturated group to monomers containing exactly one ethylenically unsaturated group is less than 1:10.

7. A conductive ink composition according to claim 1 which further comprises one or more monomers containing more than one ethylenically unsaturated group, wherein the weight ratio of monomers containing more than one ethylenically unsaturated group to monomers containing exactly one ethylenically unsaturated group is less than 1:20.

8. A conductive ink composition according to claim 1 which further comprises one or more monomers containing more than one ethylenically unsaturated group, wherein the weight ratio of monomers containing more than one ethylenically unsaturated group to monomers containing exactly one ethylenically unsaturated group is less than 1:50.

9. A conductive ink composition according to claim 1 which further comprises one or more monomers containing more than one ethylenically unsaturated group, wherein the weight ratio of monomers containing more than one ethylenically unsaturated group to monomers containing exactly one ethylenically unsaturated group is less than 1:100.

10. A conductive ink composition according to claim 1, wherein the conductive ink composition further comprises a volatile organic solvent.

11. A conductive ink composition according to claim 1, wherein the conductive ink composition is substantially free of volatile organic solvent.

12. A conductive ink composition according to claim 1, wherein at least one initiator is a photoinitiator.

13. A conductive ink composition according to claim 12, wherein the conductive ink composition hardens to a tack-free material upon exposure to radiation.

14. A conductive ink composition according to claim 12, wherein the conductive ink composition hardens to a tack-free material upon exposure to UV radiation.

15. A conductive ink composition according to claim 12, wherein the conductive ink composition hardens to a tack-free, thermoplastic material upon exposure to radiation.

16. A conductive ink composition according to claim 12, wherein the conductive ink composition hardens to a tack-free, thermoplastic material upon exposure to UV radiation.

17. A conductive ink composition according to claim 12, wherein the conductive ink composition hardens to a conductive, tack-free, thermoplastic material upon exposure to radiation.

18. A conductive ink composition according to claim 12, wherein the conductive ink composition hardens to a conductive, tack-free, thermoplastic material upon exposure to UV radiation.

19. A conductive ink composition according to claim 12, wherein the conductive ink composition is substantially free from thermal initiators.

20. A conductive ink composition according to claim 1, wherein at least one initiator is a thermal initiator.

21. A conductive ink composition according to claim 20, wherein the conductive ink composition hardens to a tack-free material upon exposure to heat.

22. A conductive ink composition according to claim 20, wherein the conductive ink composition hardens to a tack-free material upon exposure to heat.

23. A conductive ink composition according to claim 20, wherein the conductive ink composition hardens to a conductive, tack-free, thermoplastic material upon exposure to heat.

24. A conductive ink composition according to claim 20, wherein the conductive ink composition is substantially free from photoinitiators.

25. A conductive ink composition according to claim 1, wherein the conductive ink composition comprises at least one photoinitiator and at least one thermal initiator.

26. A conductive ink composition according to claim 1, wherein the conductive ink composition is formulated for ink-jet printing.

27. A conductive ink composition according to claim 1, wherein the conductive particles are conductive metal particles.

28. A conductive ink composition according to claim 27, wherein the conductive metal particles are selected from metal powder, metal flake, metal-coated beads, and combinations thereof.

29. A conductive ink composition according to claim 27, wherein the conductive metal particles comprise aluminum, silver, gold, copper, and combinations thereof.

30. A thermoplastic material comprising:
a polymerization product of a conductive ink composition according to claim 1.

31. An electronic device comprising two or more electronic components in electrical communication with one another via one or more conductive traces and/or interconnects, wherein at least some of said conductive traces and/or interconnects comprise a thermoplastic material according to claim 30.

32. An electronic device according to claim 31, wherein said electronic components are the same or different and are selected from resistors, capacitors, transistors, integrated circuits or other electronic chips, diodes, antennae, and grounds.

33. An electronic device according to claim 31, wherein the thermoplastic material forms a mechanical bond with at least one of the electronic components.

34. An electronic device according to claim 31, wherein the electronic device further comprises one or more non-electronic components and wherein the thermoplastic material forms a mechanical bond with at least one of the non-electronic components.

35. A conductive thermoplastic material comprising:
at least one thermoplastic polymer produced by polymerization of one or more monomers containing exactly one ethylenically unsaturated group; and
conductive particles dispersed in said thermoplastic polymer.

36. A conductive thermoplastic material according to claim 35, wherein the conductive thermoplastic material comprises at least one thermoplastic polymer produced by photopolymerization of one or more monomers containing exactly one ethylenically unsaturated group.

37. A conductive thermoplastic material according to claim 36, wherein the conductive thermoplastic material is substantially free of thermoplastic polymers produced by thermal polymerization of one or more monomers containing exactly one ethylenically unsaturated group.

38. A conductive thermoplastic material according to claim 35, wherein the conductive thermoplastic material comprises at least one thermoplastic polymer produced by thermal polymerization of one or more monomers containing exactly one ethylenically unsaturated group.

39. A conductive thermoplastic material according to claim 38, wherein the conductive thermoplastic material is substantially free of thermoplastic polymers produced by photopolymerization of one or more monomers containing exactly one ethylenically unsaturated group.

40. A conductive thermoplastic material according to claim 35, wherein the conductive thermoplastic material comprises at least one thermoplastic polymer produced by simultaneous thermal and photo polymerization of one or more monomers containing exactly one ethylenically unsaturated group.

41. A conductive thermoplastic material according to claim 35, wherein the conductive thermoplastic material comprises at least one thermoplastic polymer produced by photopolymerization of one or more monomers containing exactly one ethylenically unsaturated group and at least one thermoplastic polymer produced by thermal polymerization of one or more monomers containing exactly one ethylenically unsaturated group.

42. A conductive thermoplastic material according to claim 35, wherein said conductive thermoplastic material further comprises a second thermoplastic polymer.

43. A conductive thermoplastic material according to claim 35, wherein the thermoplastic material is substantially free of thermoset polymers.

44. A conductive thermoplastic material according to claim 35 which further comprises one or more thermoset polymers, wherein the weight ratio of thermoset polymers to thermoplastic polymers is less than 1:5.

45. A conductive thermoplastic material according to claim 35 which further comprises one or more thermoset polymers, wherein the weight ratio of thermoset polymers to thermoplastic polymers is less than 1:10.

46. A conductive thermoplastic material according to claim 35 which further comprises one or more thermoset polymers, wherein the weight ratio of thermoset polymers to thermoplastic polymers is less than 1:20.

47. A conductive thermoplastic material according to claim 35 which further comprises one or more thermoset polymers, wherein the weight ratio of thermoset polymers to thermoplastic polymers is less than 1:50.

48. A conductive thermoplastic material according to claim 35 which further comprises one or more thermoset polymers, wherein the weight ratio of thermoset polymers to thermoplastic polymers is less than 1:100.

49. A conductive thermoplastic material according to claim 35, wherein the conductive particles are conductive metal particles.

50. A conductive thermoplastic material according to claim 49, wherein the conductive metal particles are selected from metal powder, metal flake, metal-coated beads, and combinations thereof.

51. A conductive thermoplastic material according to claim 49, wherein the conductive metal particles comprise aluminum, silver, gold, copper, and combinations thereof.

52. An electronic device comprising two or more electronic components in electrical communication with one another via one or more conductive traces and/or interconnects, wherein at least some of said conductive traces and/or interconnects comprise a conductive thermoplastic material according to claim 35.

53. An electronic device according to claim 52, wherein said electronic components are the same or different and are selected from resistors, capacitors, transistors, integrated circuits or other electronic chips, diodes, antennae and grounds.

54. An electronic device according to claim 52, wherein the thermoplastic material forms a mechanical bond with at least one of the electronic components.

55. An electronic device according to claim 52, wherein the electronic device further comprises one or more non-electronic components and wherein the thermoplastic material forms a mechanical bond with at least one of the non-electronic components.

56. An electronic device according to claim 52, wherein the conductive particles are conductive metal particles.

57. An electronic device according to claim 56, wherein the conductive metal particles are selected from metal powder, metal flake, metal-coated beads, and combinations thereof.

58. An electronic device according to claim 56, wherein the conductive metal particles comprise aluminum, silver, gold, copper, and combinations thereof.
